(19) United States
(12) Patent Application Publication
(10) Pub. No.: US 2006/0276370 A1
(43) Pub. Date: Dec. 7, 2006

(54) Fabric care compositions

(75) Inventors: Shulin Larry Zhang, West Chester, OH (US); Eric Christopher Wells, Liberty Township, OH (US); Michelle Marie Mulvaney, Cincinnati, OH (US); Glenn Thomas Jordan IV, Indian Springs, OH (US); Mark Robert Sivik, Mason, OH (US); Yonas Gizaw, Cincinnati, OH (US); Joseph Dean Heatherly, Morrow, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/443,756

(22) Filed: May 31, 2006

Related U.S. Application Data
(60) Provisional application No. 60/687,362, filed on Jun. 3, 2005.

(51) Int. Cl. C11D 1/66

(52) U.S. Cl. 510/470

(57) ABSTRACT

A fabric care composition and process for using the composition to treat fabrics are provided. The fabric care composition comprises a sucrose ester, a cationic polysaccharide and a dispersing medium, wherein the charge density of the cationic polysaccharide is from about 0.05 to about 5.5 meq/gram. Optionally, deposition agents and adjunct materials may also be included. The present compositions are used to treat fabrics to impart one or more of the following benefits tot eh treated fabrics: improved fabric softness, wrinkle reduction after drying, ease of ironing, in-wear shape retention, fabric elasticity, fabric tensile strength, fabric tear strength, and/or color protection.

### CROSS REFERENCE TO RELATED APPLICATIONS

This application claims the benefit of U.S. Provisional Application Ser. No. 60/687,362, filed on Jun. 3, 2005.

### FIELD OF INVENTION

The present invention relates to a composition comprising a sucrose ester, a cationic polysaccharide and a dispersing medium wherein the charge density of the cationic polysaccharide is from about 0.05 to about 5.5 meq/gram. Optionally, deposition agents or adjunct materials may also be included. The present compositions are used to treat fabrics to impart one or more of the following benefits tot eh treated fabrics: improved fabric softness, wrinkle reduction after drying, ease of ironing, in-wear shape retention, fabric elasticity, fabric tensile strength, fabric tear strength, and/or color protection. Processes for using the composition to treat fabrics are also provided.

### BACKGROUND OF THE INVENTION

Fabric care compositions, such as fabric softening compositions, are generally used during the rinse cycle or drying cycle of a typical laundry process to provide improved softness and freshness to the laundered fabric articles. When added during the rinse cycle, the fabric care compositions are typically liquid compositions. When added during the drying cycle, the fabric care compositions are typically solid compositions that are incorporated onto a nonwoven substrate that is placed in the laundry dryer.

There are unique challenges associated with fabric care compositions for through-the-rinse applications. On one hand, suitable active materials must be able to provide the desired benefits in the laundered fabric articles. On the other hand, these active materials need to be effectively deposited onto the fabric articles from the bulk of rinse liquor under the laundering conditions. It has been found that the softening performance of cationic fabric care actives having long alkyl chains are very sensitive to the presence of anionic detergent components carried over from the wash into the rinse. Specifically, it is observed that the anionic detergent components tend to reduce the softening effect provided by these cationic fabric care actives. It is hypothesized that the anionic detergent component and the cationic fabric care active may form a cationic/anionic complex which has a tendency to precipitate out of solution, thus, the fabric care active does not get deposited onto the fabric surface efficiently. Moreover, even if the fabric care active is deposited onto the fabrics, since it is bound in a neutralized complex, it is ineffective as a softening agent. Deposition aids and/or anion scavengers have been employed in this type of application.

Typical fabric care compositions can provide various fabric care benefits in varying degrees; some examples of the benefits include fabric softening, fabric lubrication, fabric relaxation, wrinkle reduction, easier of ironing, abrasion resistance, fabric smoothing, static reduction and perfuming. Fabric care active commonly found in the fabric care compositions are alkyl-modified quaternary ammonium compounds such as diester quaternary ammonium compounds (DEQA); polyquaternary ammonium compounds; triethanolamine esterified with carboxylic acid and quaternized (so called “esterquat”); amino esterquats; cationic diesters; betaine esters; betaines. Additional actives include silicone or silicone emulsions comprising aminosilicones, cationic silicones, quat/silicone mixtures, and functionalized PDMS. Though these actives are capable of delivering softness benefit to the treated fabric articles, they often deliver other undesirable results to the treated fabric articles as well, such as greasy feel, reduced water absorbency, color aging or yellowing. There are other characteristics of these actives that can use some improvements, such as biodegradability and toxicity.

To overcome these shortcomings, it has been proposed to use fabric care compositions comprising mostly naturally derived materials such as sugar and vegetable oil derivatives as the benefit agents. Exemplary compositions containing sugar or vegetable oil derived softeners are disclosed in GB 1 601 359; U.S. Pat. No. 5,447,643; U.S. Pat. No. 5,498,350; U.S. Pat. No. 6,410,501; U.S. Pat. No. 6,436,896; U.S. Pat. No. 6,514,931; U.S. Pat. No. 6,727,220; WO 98/16538; WO 01/034315; and WO 98/16538.

There exists a continuing need to improve the fabric care compositions for better performance and better value for the users. Furthermore, there is a continuing need to reduce the amount of petroleum-derived materials (such as cationic deposition agents or quaternary ammonium fabric softeners) in the fabric care compositions.

### SUMMARY OF THE INVENTION

The present invention relates to a fabric care composition comprising:
(a) a sucrose ester fabric care material;
(b) a cationic polysaccharide;
(c) an emulsifier comprising a cationic surfactant, an amphoteric surfactant or mixtures thereof; and
(d) a dispersing medium.

The composition may optionally comprise a deposition agent, an adjunct, or mixtures thereof.

### DETAILED DESCRIPTION OF THE INVENTION

Definitions

As used herein, “fabric article” means an article composed of fabrics and/or fibers. Such articles include, but are not limited to, clothing, towels and other bath linens, bed linens, table cloths, carpets, curtains, upholstery coverings, sleeping bags, tents, shoes, and car interior (such as car seat covers, car floor mats).

As used herein, “fabric care material” means a material or combination of materials that can deliver one or more of the following benefits to a fabric article: fabric softening, fabric lubrication, fabric relaxation, durable press, wrinkle resistance, wrinkle reduction, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency, refreshing, anti-microbial, odor resistance, and mixtures thereof.

As used herein, the terms “emulsifiers” and “surfactants” are synonymous.

As used herein, the articles “a” and “an”, when used in a claim, are understood to mean one or more of the material that is claimed or described.

Unless otherwise noted, the term “molecular weight” refers to the weight-average molecular weight, which can be measured according to a gel permeation chromatography (“GPC”) method described in U.S. Patent Publication 2003/0154883 A1.

Unless otherwise noted, all component or composition levels are in reference to the active level of that component or composition, and are exclusive of impurities, for example, residual solvents or by-products, which may be present in commercially available sources.

Unless otherwise indicated, all percentages and ratios are calculated based on weight of the total composition.

Fabric Care Composition

Suitable fabric care materials derived from non-petroleum sources can be found in the family of saccharides and their derivatives, such as sugar esters, especially sucrose esters.

Conventional fabric care actives are based on quaternary ammonium compounds, which are cationic. These saccharide-based fabric care materials, however, are nonionic. It is previously believed that deposition of nonionic fabric care materials are not sensitive to the carried-over anionic detergent components, since there are no strong interactions between opposite charges. We are surprised to discover that the performance of these nonionic fabric care materials can be improved significantly by incorporating deposition agents that interact with the anionic detergent components. Additionally, we discover that by using a cationic polymer having the structural similarity, hence compatibility, with the deposition agent, the undesirable effects of anionic detergent components on the fabric care materials can be further reduced.

One aspect of the present invention is to provide a fabric care composition which comprises a sucrose ester fabric care material, a cationic polysaccharide having a charge density of from about 0.05 to about 5.5 meq/gram, a dispersing medium, and optionally, other deposition agents and one or more adjunct materials.

In one embodiment, the fabric care composition comprises a sucrose ester; a cationic polysaccharide that bears cationic charges from about 0.05 to about 5.5 meq/gram in a conventional aqueous laundering conditions; a dispersing medium, such as water, alcohols, diols; an emulsifier, such as cationic surfactants, amphoteric surfactants; optionally a deposition agent (such as diester or dialkyl quaternary ammonium compounds); and optionally, one or more adjunct materials (such as other fabric care agents and adjunct materials) selected from the group consisting of softening agents, perfumes, wetting agents, viscosity modifiers, pH buffers, antibacterial agents, antioxidants, radical scavengers, chelants, antifoaming agents, and mixtures thereof.

In another embodiment, the fabric care composition comprises from about 1% to about 70% by weight of the fabric care composition of a sucrose ester, from about 0.1% to about 20% by weight of the fabric care composition of a cationic polysaccharide, and from about 0.3% to about 25% by weight of an emulsifier, and the balance a dispersing medium.

In another embodiment, the fabric care composition comprises a sucrose ester and a cationic polysaccharide having the weight ratio ranging from about 500:1 to about 1:20, preferably from about 100:1 to about 1:2, more preferably from about 20:1 to about 1:1.

In another embodiment, the weight ratio of the sucrose ester plus the cationic polysaccharide to the surfactant ranges from about 1000:1 to about 1:20, preferably from about 100:1 to about 1:1, more preferably from about 10:1 to about 1:2.

In another embodiment, the fabric care composition comprises from about 1% to about 70% by weight of the composition of a cyclic polyol ester fabric care material (such as sucrose ester), from about 0.1% to about 20% by weight of the composition of a cationic polysaccharide (such as hydrolyzed cationic starch), from about 0.3% to about 25% by weight of the composition of a surfactant (such as a cationic surfactant or an amphoteric surfactant), optionally from about 30% to about 98% by weight of the composition of a dispersing medium, optionally from about 0.1% to about 15% by weight of the composition of a deposition agent, and optionally from about 0.1% to about 15% by weight of the composition of one or more adjunct materials.

The fabric care composition of the present invention also encompasses the solid or dry form, the latter is typically loaded in or onto a substrate. In its solid or dry form, the composition comprises less than about 10%, or from about 0% to about 5%, or from about 0.1% to about 2%, by weight of the composition of a dispersing medium.

The liquid compositions of the present invention can be used by manual pouring from a container and will typically have a viscosity of at least about 1 centipoise (0.001 Pa·s) and less than about 2000 centipoises (2 Pa·s), preferably less than about 500 centipoises (0.5 Pa·s), more preferably less than about 200 centipoises (0.2 Pa·s), and even more preferably less than about 120 centipoises (0.12 Pa·s). For purposes of the present invention, the viscosities of the present compositions are measured at 25° C. with a Brookfield® viscometer using a No. 2 spindle at 60 rpm.

The compositions of the present invention will generally have a pH of from about 2 to about 10, preferably from about 2 to about 8, and more preferably from about 2 to about 7.

The present compositions can be liquid or solid (e.g., granules, powders, tablets), and are preferably liquid compositions. Liquid compositions of the present invention can be clear or opaque (dispersions). The present compositions can also be provided in a unit dose form, for example, as a liquid composition contained in a water-soluble film (e.g. polyvinyl alcohol film) or as a solid tablet unit dose form. The present composition can also be provided in or on a sheet substrate.

The compositions of the present invention can also be dosed in the laundry process through other means such as hand pump, squeeze bottle, squeeze tube, bars, granules, particles or other forms that can be dispersed into the wash or rinse liquor with or without addition device.

The present invention also encompasses using the compositions to treat fabrics during in a laundering process. The present invention thus further relates to methods of treating fabrics; the method comprises the step of contacting the fabrics with an effective amount of a fabric care composition of the present invention; the contacting step can occur during the wash cycle, the rinse cycle, the drying cycle, and combinations thereof.

The present invention thus further relates to methods of treating fabrics to provide one or more benefits selected from the group consisting of fabric softening, fabric lubrication, fabric relaxation, durable press, wrinkle resistance, wrinkle reduction, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency, refreshing, anti-microbial, odor resistance.

Sucrose Ester-Based Fabric Care Materials

The fabric care material useful in the compositions of the present invention comprises a sucrose ester, which is composed of a sucrose moiety having one or more of its hydroxyl groups esterified.

Sucrose is a disaccharide having the following formula:

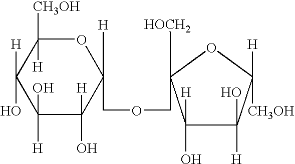

Alternatively, the sucrose molecule can be represented by the formula: M(OH)₈, wherein M represents the disaccharide backbone of sucrose and total of 8 hydroxyl groups are present in the sucrose molecule.

Thus, sucrose ester can be represented by the following formula:
M(OH)₈₋ₓ(OC(O)R¹)ₓ
wherein x is the number of esterified hydroxyl groups and is an integer selected from 1 to 8, or from 2 to 8, or from 3 to 8, or from 4 to 8; and R¹ moieties are independently selected from C1-C22 alkyl or C1-C30 alkoxy, which may be linear or branched, cyclic or acyclic, saturated or unsaturated, substituted or unsubstituted.

In one embodiment, the sucrose ester molecule may comprise R¹ moieties that are independently selected from linear alkyl or alkoxy moieties of varying chain lengths. In a specific embodiment, greater than about 20%, or greater than about 50%, or greater than about 80% of the R¹ moieties in a sucrose ester molecule are C18 linear alkyl or alkoxy moieties.

In another embodiment, the R¹ moieties of the sucrose ester molecule may comprise a mixture of saturate and unsaturated alkyl or alkoxy moieties; the degree of unsaturation can be measured by “Iodine Value” (hereinafter referred as “IV”, as measured by the standard AOCS method). The sucrose esters suitable for use herein may have an IV ranging from about 1 to about 150, or from about 2 to about 100, or from about 5 to about 85. Furthermore, the R¹ moieties may be hydrogenated to reduce the degree of unsaturation.

In a further embodiment, the unsaturated R¹ moieties may comprise a mixture of “cis” and “trans” configurations about the unsaturated sites. The cis/trans ratios may range from about 1:1 to about 50:1, or from about 2:1 to about 40:1, or from about 3:1 to about 30:1, or from about 4:1 to about 20:1.

The sucrose esters are present in the fabric care composition of the present invention at levels from about 1% to about 70%, or from about 2% to about 50%, or from about 3% to about 30%, by weight of the composition.

Cationic Polysaccharides

The compositions of the present invention also contain cationic polysaccharides. As used herein, the term “cationic polysaccharide” refers to a polysaccharide that has been chemically modified to provide the polysaccharide with a net positive charge in a pH neutral aqueous medium.

The non-modified polysaccharides can be extracted from a variety of sources including plant sources (such as tubers, legumes, seeds, grains and algaes), animal sources, or produced by organisms (such as bacteria, fungi, prokaryotes, and eukaryotes). Suitable polysaccharides from these sources include, but are not limited to, starch, cellulose, pectin, carageenan, guar gums, xanthans, dextrans, curdlans, chitosan, chitin, and the like.

The chemical modification to impart net positive charge to the polysaccharides includes, but is not limited to, the addition of amino and/or ammonium group(s) into the polysaccharides molecules. These quaternary ammonium substituents may be introduced into the polysaccharides via reactions with such as trimethylhydroxypropyl ammonium chloride, dimethylstearylhydroxypropyl ammonium chloride, or dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125.

In one embodiment of the present invention, the cationic polysaccharide is an ammonium quaternary substituted polysaccharide having a net charge density (expressed as meq of nitrogen per gram of cationic polysaccharide) from about 0.05 to about 5.5 meq/gram, preferably from about 0.05 to about 3 meq/gram, and more preferably from about 0.05 to about 0.6 meq/gram. The charge density of an ammonium quaternary substituted polysaccharide may be expressed in terms of weight percentage of N in the polymer, or in terms of meq/gram. The conversion factors between these two expressions are as following: 1 wt % N=0.71 meq/gram, or 1.0 meg/gram=1.4 wt % N.

The cationic polysaccharide in the composition of the present invention may include one or more additional modifications. For example, these modifications may include cross-linking, stabilization reactions (such as alkylation and esterification), phophorylations, hydrolyzations.

Commercial available cationic polysaccharides suitable for use in the present invention include, but are not limited to Jaguar® (cationic guar polymers from Rhodia), Polygel® (cationic starches from Sigma), Softgel®, Amylofax® and Solvitose® (cationic starches from Avebe), Celquats® (cationic cellulose derivatives from National Starch), and Ucare® (cationic cellulose derivatives from Amerchol).

In one embodiment of the composition of the present invention, the cationic polysaccharide is a hydrolyzed cationic starch. A suitable method of hydrolyzing starch is described by U.S. Pat. No. 4,499,116, with specific mention at column 4.

The degree of hydrolysis of a hydrolyzed cationic starch may be measured by Water Fluidity (WF), which is a measure of the solution viscosity of hydrolyzed starches. A suitable method for determining WF is described at columns 8-9 of U.S. Pat. No. 4,499,116. One skilled in the art will readily appreciate that cationic starch having a relatively high degree of hydrolysis will have low solution viscosity, hence a high water fluidity (WF) value. One embodiment of the composition of the present invention comprises a cationic starch with a solution viscosity (measured by WF) of a value from about 50 to about 84, preferably from about 65 to about 84, more preferable 70 to about 84.

In another embodiment of the composition of the present invention, the cationic polysaccharide has a molecular weight ranging from about 50,000 to about 10,000,000 daltons; more preferably from about 50,000 to about 7,000,000 daltons, more preferably from about 50,000 to about 4,000,000 daltons, and even more preferably from about 50,000 to about 3,000,000 daltons. In yet another embodiment, the cationic polysaccharide is a hydrolyzed cationic starch having a molecular weight from about 50,000 to about 2,000,000 daltons.

The cationic polysaccharides are present in the fabric care composition of the present invention at levels from about 1% to about 20%, or from about 2% to about 15%, or from about 3% to about 10%, by weight of the composition. In one embodiment, the cationic polysaccharide is present at from about 1 to about 5% by weight of the composition.

Emulsifiers

Optionally, the composition of the present invention may comprise emulsifiers at the following levels: from about 0.3% to about 25%, or from about 0.5% to about 20%, or from about 1% to about 10%, by weight of the composition. Suitable emulsifiers include cationic emulsifiers, amphoteric emulsifiers, and mixtures thereof.

Suitable cationic surfactants include, but are not limited to quaternary ammonium surfactants, which can have up to 26 carbon atoms.
a) alkoxylate quaternary ammonium (AQA) surfactants as discussed in U.S. Pat. No. 6,136,769;
b) dimethyl hydroxyethyl quaternary ammonium as discussed in U.S. Pat. No. 6,004,922;
c) polyamine cationic surfactants as discussed in WO 98/35002, WO 98/35003, WO 98/35004, WO 98/35005, and WO 98/35006;
d) cationic ester surfactants as discussed in U.S. Pat. Nos. 4,228,042, 4,239,660 4,260,529 and U.S. Pat. No. 6,022,844; and
e) amino surfactants as discussed in U.S. Pat. No. 6,221,825 and WO 00/47708, specifically amido propyldimethyl amine.

In one embodiment, the cationic surfactant comprises quaternary ammonium surfactants that also provide anti-static and/or softening benefits. Suitable quaternary ammonium surfactants can be selected from the group consisting of mono C₆-C₁₆, preferably C₆-C₁₀ N-alkyl or alkenyl ammonium surfactants, wherein the remaining N positions are substituted by methyl, hydroxyethyl or hydroxypropyl groups. In another embodiment, the cationic surfactant is C₆-C₁₈ alkyl or alkenyl ester of a quaternary ammonium alcohol, such as quaternary choline esters. In yet another embodiment, the cationic surfactants have the formula below: 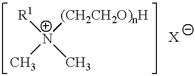
wherein R¹ is a C₈-C₁₈ hydrocarbyl, preferably C₈₋₁₄ alkyl, more preferably C₈, C₁₀ or C₁₂ alkyl, and X⁻ is a water soluble anionic species, such as chloride, bromide or methyl sulfate.

In one embodiment, emulsifiers in the composition include amphoteric surfactants such as amine oxides, betaines, cetyltrimethyl ammonium chloride, and mixtures thereof. In another embodiment, the emulsifiers in the composition further include nonionic surfactants, such as alkyl ethoxylates, alkyl phenol alkoxylates or other condensates of alkylene oxide groups with an organic hydrophobic moiety composed of aliphatic or alkyl aromatic moieties, polyalkylene glycol copolymers, mid-chain branched alcohols or alkyl alkoxylates, and the like. In yet another embodiment, the emulsifiers in the composition does not include those nonionic surfactants.

Dispersing Medium

The fabric care composition of the present invention optionally comprises a dispersing medium. Suitable dispersing medium include, but are not limited to, water, water soluble solvents selected from the group consisting of C4 to C10 glycol ethers, C2 to C7 glycols, polyethers, such as glycerin, and mixtures thereof.

The fabric care composition may comprise, based on weight percent of the fabric care composition, from about 30 wt % to about 99 wt %, or from about 40 wt % to about 90 wt %, or from about 50 wt % to about 70 wt % of the dispersing medium. Typically, water comprises greater than about 30 wt %, or greater than about 60 wt % of the fabric care composition; the balance of the dispersing medium comprises water-soluble or water-dispersible solvents.

The pH of the fabric care composition may be in one of the following ranges: from about 2 to about 10, or from about 3 to about 9, or from about 4 to about 8, or from about 5.5 to about 7.5. Commonly known pH buffers, such as those disclosed below in the “Adjunct Materials” section, can be used to adjust and/or control the pH of the composition.

The dispersing medium may optionally comprise the following water-soluble or water-dispersible solvents: ethanol, propanol, isopropanol, n-butanol, t-butanol, propylene glycol, ethylene glycol, dipropylene glycol, propylene carbonate, butyl carbitol, phenylethyl alcohol, 2-methyl 1,3-propanediol, hexylene glycol, glycerol, polyethylene glycol, 1,2-hexanediol, 1,2-pentanediol, 1,2-butanediol, 1,4-cyclohexanediol, pinacol, 1,5-hexanediol, 1,6-hexanediol, 2,4-dimethyl-2,4-pentanediol, 2,2,4-trimethyl-1,3-pentanediol, 2-ethyl-1,3-hexanediol, phenoxyethanol, or mixtures thereof.

Solvents are typically incorporated in the compositions of the present invention at a level of less than about 20%, preferably less than 10% by weight of the composition. In other embodiments, such as clear compositions, suitable solvents have a ClogP of from about −2.0 to about 2.6, preferably from about −1.7 to about 1.6, and more preferably from about −1.0 to about 1.0, which are described in detail WO 99/27050 by Frankenbach et al.

Deposition Agents

The fabric care composition may optionally comprise deposition agents including, but not limited to, I) non-quaternary materials that are (a) acyclic polymers or copolymers having nitrogen moieties in the backbone or in the pendant groups, or (b) vinyl polymers or copolymers having nitrogen heterocyclics in the pendant groups; II) non-polysaccharide polyquaterniums and other polymeric cationic quaternary materials; and mixtures thereof.

The deposition agents suitable for use herein are polymeric materials with a molecular weight generally in one of the following the ranges: from about 1000 to about 1,000,000 daltons, or from about 1000 to about 200,000 daltons, or from about 2500 to about 1,000,000 daltons, or from about 5000 to about 500,000 daltons. In one embodiment, the deposition agent is polyacrylamide or derivatives thereof, and the molecular weight of the deposition agent ranges from about 1,000,000 to about 15,000,000 daltons.

When present, each deposition agent comprises, based on total composition weight, at the following levels, from about 0.1% to about 20%, or from about 0.2% to about 15%, or from about 0.2% to about 10 wt %, or from about 0.2% to about 5%.

In some embodiments of the present invention, suitable deposition agents are acyclic polymers or copolymers derived from monomers having nitrogen moieties, including but not limited to, amine, imine, amide, imide, acrylamide, methacrylamide, amino acid, and mixtures thereof.

Nonlimiting examples of suitable deposition agents are described below:

Acrylic Polymers or Copolymers Having Nitrogen Moieties

a) polyvinylamine (PVAm): examples of this polymeric material are available as Catiofast® PR8085, PR8106, PR8134, all of which are from BASF;
b) polyethyleneimine (PEI): examples of this polymeric material are available as Lupasol® and Polymin® from BASF, or as Catiofast® PL, SF, GM, PR8138, all of which are from BASF;
c) grafted and crosslinked polyAmido-polyethyleneimine 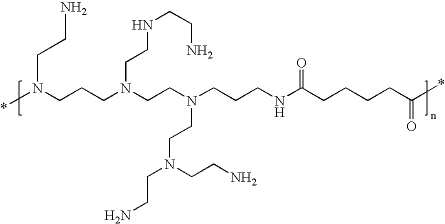
d) ethoxylated polyethyleneimine (PEI-E) 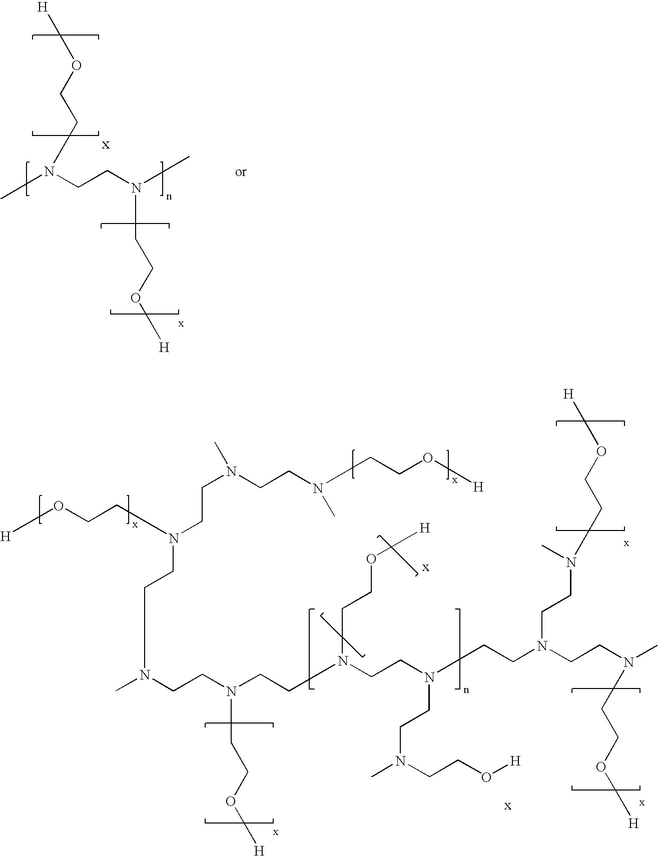
wherein, x=1-40;
e) polyacrylamide;
f) poly(2-dimethylaminoethyl methacrylate);
g) poly(amino acids): for example, polylysine would have the following formula: 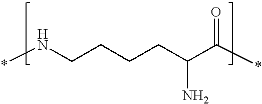
additional examples of poly(amino acids) are selected from the group consisting of:
   (1) homo-condensates of basic amino acids, said amino acids selected from the group consisting of lysine, ornithine, arginine, and tryptophan;
   (2) co-condensates of basic amino acids, said amino acids selected from the group consisting of lysine, ornithine, arginine, and tryptophan;
   (3) co-polymers produced from the reaction of one or more basic amino acids with one or more co-condensable compounds;
   4) co-polymers produced from the reaction of one or more homo-condensates from (1) or co-condensates from (2) with one or more co-condensable compounds;
   (5) crosslinked basic amino acid-containing polymers, said crosslinked polymers comprising:
      i) one or more basic amino acids;
      ii) co-polymers of (i) and one or more co-condensable compounds;
      iii) optionally co-polymers produced from the reaction of one or more homo-condensates from (1) or co-condensates from (2) with one or more co-condensable compounds; and
      iv) one or more crosslinking unit;
   wherein at least one crosslinking unit is derived from a crosslinker which comprises at least two functional groups;
   (6) co-condensates formed from the reaction of one or more compounds selected from the group consisting of: (i) basic amino acids; (ii) co-condensable compounds; (iii) crosslinking agents; and
   (7) mixtures thereof.
h) polylysine aminocaproic acid derivatives 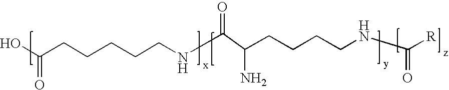
   Vinyl Polymers or Copolymers Having Nitrogen Heterocyclic Pendant Moieties

In some embodiments of the present invention, suitable deposition agents are vinyl polymers or copolymers derived from vinyl monomers with nitrogen heterocyclic pendant moieties having the general formula: 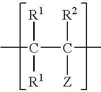
wherein R¹, R² are independently hydrogen, halogen, linear or cyclic, saturated or unsaturated C1-C4 alky or alkoxy, substituted or unsubstituted phenyl, benzyl, naphthayl or heterocyclics, and mixtures thereof; Z is nitrogen heterocyclics, including nitrogen heterocyclic N-oxides.

Nonlimiting examples of these deposition agents are described below:
a) Polyvinylpyrrolidone (PVP)
b) Polyvinylpyridine
c) Polyvinylpyridine-N-oxide (PVNO)
d) Polyvinylpyrrolidone vinyl imadazole (PVPVI)
e) Copolymers of vinylpyrrolidone and dimethylaminoethyl methacrylate
   Non-polysaccharide Polyquaterniums and Other Polymeric Cationic Quaternary Materials

In some embodiments of the present invention, suitable deposition agents are non-polysaccharide polyquaterniums, other polymeric cationic quaternary materials or mixtures thereof. As used herein, the term “Polyquaternium-x” has the same meaning as defined in INCI (International Nomenclature Cosmetic Ingredient). These cationic quaternary materials can be paired with anions, including but not limited to halides or SO₃CH₃⁻. Nonlimiting examples of these deposition agents are described below:
a) Polyquaternium-2: examples of this polymeric material are available as Mirapol® A-15 (from Rhodia);
b) Polyquaternium-6 (N,N-dimethyl-N-2-propen-1-ammonium chloride homopolymer): examples of this polymeric material are available as Merquat® 100 (from Calgon), Percol® 370 or Magnafloc® 370 (from CIBA);
c) Polyquaternium-7 (copolymer of acrylamide and N,N-dimethyl-N-2-propen-1-ammonium chloride): examples of this polymeric material are available as Merquat® 550 (from Calgon) or Mirapol® 550 (from Rhodia);
d) Polyquaternium-11 (quaternized poly(vinylpyrrolidone/dimethylaminoethyl acrylate): examples of this polymeric material are available as Gafquat® 755, 755N, 734 (from ISP);
e) Polyquaternium-16 (copolymer of polyvinylpyrrolidone and imidazolinium methylchloride): examples of this polymeric material are available as Luviquat® FC and Luviquat® HM (from BASF);
f) Polyquaternium-17: examples of this polymeric material are available as Mirapol® AD-1 (from Rhodia);
g) Polyquaternium-18: examples of this polymeric material are available as Mirapol® AZ-1 (from Rhodia);
h) Polyquaternium-22 (copolymer of sodium acrylate and dimethyl diallyl ammonium chloride): examples of this polymeric material are available as Merquat® 280 and 295 (from Calgon);
i) Polyquaternium-28 (copolymer of vinylpyrrolidone and methacrylate amidopropyl/trimethylammonium chloride): examples of this polymeric material are available as Gafquat® HS-100 (from ISP);
j) cationic polyacrylamide such as polyacrylamide ethyl trimethylammonium cation 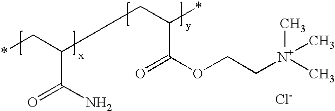
examples of this polymeric material are available as Sedipur® CF (from BASF) wherein the cation is paired with a chloride anion; and
k) poly(2-acryloyloxyethyl)trimethylammonium cation, which may be paired with anion such as methylsulfate; 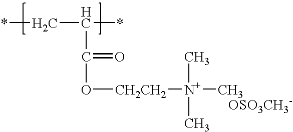
l) polymethacrylamidopropyl trimethylammonium cation 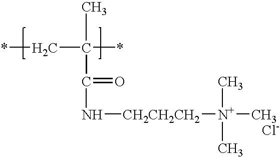
examples of this polymeric material are available as Polycare® 133 (from Rhodia), wherein the cation is paired with a chloride anion;
m) copolymers containing polyamide, polyether and polyethylenimine, such as: 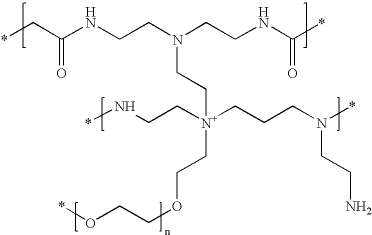
examples of this polymeric material are available as Polymin® from BASF.
   Adjunct Materials

The fabric care composition may optionally comprise adjunct materials. Adjunct materials include, but are not limited to, fabric care materials, perfumes, wetting agents, nonionic polymers, viscosity modifiers, pH buffers, antibacterial agents, antioxidants, radical scavengers, chelants, antifoaming agents, and mixtures thereof.

Except where noted otherwise, each adjunct material is optionally present, based on total composition weight, at the following levels, no more than about 30 wt %, or no more than about 20 wt %, or no more than about 10 wt %; and greater than about 0.01 wt %, or greater than about 0.1 wt %, or greater than about 1 wt %.

In a specific embodiment of the present invention, the composition may optionally comprise one or more fabric care materials. These fabric care material provides one or more fabric benefits including, but not limited to, fabric softening, fabric lubrication, fabric relaxation, durable press, wrinkle resistance, wrinkle reduction, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency, refreshing, anti-microbial, odor resistance, and mixtures thereof. Representative and nonlimiting examples of fabric care materials, such as softening agents, are described below.

Softening Agents

Exemplary softening agents include, but are not limited to, diester quaternary ammonium compounds (DEQA); polyquaternary ammonium compounds; triethanolamine esterified with carboxylic acid and quaternized (so called “esterquat”); amino esterquats; cationic diesters; betaine esters; and mixtures thereof. More detailed descriptions of these and other softening agents are disclosed in GB 808,265; GB 1,161,552; DE 4,203,489; EP 221,855; EP 503,155; EP 507,003; EP 803,498; FR 2,523,606; JP 84-273918; JP 2-011545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; U.S. Pat. No. 5,747,443; U.S. Pat. No. 5,759,990; U.S. Pat. No. 6,323,172; U.S. Pat. No. 6,369,025; U.S. Pat. No. 6,486,121; and WO 99/27050.

Nonlimiting examples of quaternary ammonium type softeners may be selected from the group consisting of: N,N-dimethyl-N,N-di(tallowyloxyethyl)ammonium methylsulfate, N-methyl-N-hydroxyethyl-N,N-di(canoyloxyethyl)ammonium methylsulfate, N,N-ditallow N,N-dimethyl ammonium chloride, N,N-ditallowylethanol N,N-dimethyl ammonium chloride, and mixtures thereof. These and other quaternary ammonium type softeners are commercially available under the tradenames Adogen®, Reweoquat®, Varisoft® (all are available from Degussa) and Armosoft® (from Akzo)

Additional examples of non-silicone fabric softening agents and deposition agents are disclosed in EP 902 009; WO 99/58492; U.S. Pat. No. 4,137,180; WO 97/08284; WO 00/70004; WO 00/70005; WO 01/46361; WO 01/46363; WO 99/64661; WO 99/64660; JP 11-350349; JP11-081134; and JP 11-043863.

Some of the softening agents are described in details below. Suitable protonable amines include protonable amines having the general formula below: 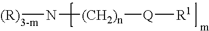
wherein the index m=0, 1, 2 or 3; the index n=1, 2, 3 or 4, preferably n is 2 or 3, more preferably n is 2; each R is independently selected from C₁-C₂₂ alkyl, C₁-C₂₂ hydroxyalkyl or a benzyl group; each R¹ is independently selected from C₁₁-C₂₂ linear alkyl, C₁₁-C₂₂ branched alkyl, C₁₁-C₂₂ linear alkenyl, or C₁₁-C₂₂ branched alkenyl; and each Q may be a carbonyl, carboxyl, or amide moiety.

Suitable alkylated quaternary ammonium compounds (so called “quats”), include mono-alkyl quats, di-alkyl, tri-alkyl quats and tetra-alkyl quats and certain cationic surfactants. Suitable mono-alkyl quats, di-alkyl, tri-alkyl quats and tetra-alkyl quats typically have the general formula below: 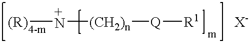
wherein the index m=0, 1, 2, 3 or 4; the index n=1, 2, 3 or 4, preferably n is 2 or 3, more preferably n is 2; each R is independently selected from C₁-C₂₂ alkyl, C₁-C₂₂ hydroxyalkyl, or a benzyl group; each R¹ is independently selected from C₁₁-C₂₂ linear alkyl, C₁₁-C₂₂ branched alkyl, C₁₁-C₂₂ linear alkenyl, or C₁₁-C₂₂ branched alkenyl; X⁻ is a water soluble anionic species such as chloride, bromide or methyl sulfate, and Q may be a carbonyl, carboxyl, or amide moiety.

Other suitable fabric softening materials may be polymeric materials such as polyacrylates, polyvinylalcohols, polyethyleneglycols, and derivatives or copolymers of the aforementioned materials.

Other Adjunct Materials

Nonlimiting examples of viscosity modifiers include salts containing and other alkali or alkaline earth metal cations and halide anions, such as CaCl₂, MgCl₂, NaCl and the like, and mixtures thereof. Polymeric viscosity modifiers such as guar gum, polysaccharides, and mixtures thereof are also suitable.

Nonlimiting examples of nonionic polymers include polyethylene glycol, polyvinyl alcohol, alkoxylated polyethyleneterephthalate.

Nonlimiting examples of pH buffers include citric acid, lactic acid, succinic acid, phosphoric acid, sodium bicarbonate, and mixtures thereof.

Nonlimiting examples of antibacterial agents include didecyl dimethyl ammonium chloride, which is available under the tradename Uniquat® (from Lonza), 1,2-benzisothiozolin-3-one, which is available under the tradename Proxel® (from Zeneca Inc.), dimethylol-5,5-dimethylhydantoin, which is available under the tradename Dantoguard® (from Lonza) and 5-Chloro-2-methyl-4-isothiazolin-3-one/2-methyl-4-isothiazolin-3-one, which is available under the tradename Kathon® (from Rohm and Haas).

The antioxidants include, but are not limited to tocopherol acetates, quinines, polyphenols, and mixtures thereof.

The radical scavengers include, but are not limited to propyl gallate, polyimines, trimethoxy benzoic acid and mixtures thereof.

The chelants include, but are not limited to diethylene triamine pentaacetic acid, ethylene diamine teraacetic acid, diethylene triamine pentamethylethylene phosphonic acid, citric acid and mixtures thereof.

The antifoaming agent include, but are not limited to silicone oils, ethoxylated surfactants, Tetronics® (available from BASF), and mixtures thereof.

The perfume materials may be obtained from one or more of the following perfume material suppliers Firmenich (Geneva, Switzerland), Givaudan (Argenteuil, France), IFF (Hazlet, N.J.), Quest (Mount Olive, N.J.), Bedoukian (Danbury, Conn.), Sigma Aldrich (St. Louis, Mo.), Millennium Specialty Chemicals (Olympia Fields, Ill.), Polarone International (Jersey City, N.J.), Fragrance Resources (Keyport, N.J.), and Aroma & Flavor Specialties (Danbury, Conn.).

Suitable particulate materials include inorganic or organic particulates such as polymeric particles, clays, talcs, zeolites and mixtures thereof. Suitable polymeric particles typically have an average particle size less than about 10 microns, preferably less than 5 microns, more preferably less than about 1 micron. Such particles may comprise polyethylene, polystyrene, polypropylene and mixtures thereof. Suitable clay materials include phyllosilicate clays with a 2:1 layered structure; and smectite clays such as pyrophyllite, montmorillonite, hectorite, saponite and vermiculite, and micas. Particularly suitable clay materials include smectite clays described in U.S. Pat. No. 4,062,647. Other disclosures of suitable clay materials for fabric softening purposes include European patent specification EP 26528A1; U.S. Pat. No. 3,959,155 and U.S. Pat. No. 3,936,537.

Other suitable adjunct materials include, but are note limited to, preservatives such as benzyl alcohol, methyl paraben, propyl paraben and imidazolidinyl urea; suspending agents such as magnesium/aluminum silicate; sequestering agents such as disodium ethylenediamine tetraacetate; and certain synthetic or naturally-derived oils and/or fats, such as certain triglycerides, mineral oils, and mixtures thereof. Specific examples of oils or fats suitable for use herein as adjunct materials include, but are not limited to, triglycerides from beef tallow, palm oil, cottonseed oil, canola oil, and soybean oil, all with varying levels of hydrogenation, paraffin oils, and mixtures thereof.

Additional adjunct materials further include, but are not limited to, wrinkle releasing/prevention agent, anti-static agent, crystal modifier, soil release/prevention agent, colorant, brightener, odor reducer/eliminator, deodorizer/refresher agent, stain repellent, color enhancer, perfume release and/or delivery agent, shape retention agent, fiber rebuild agent, fiber repair agent, and mixtures thereof. Additional examples of suitable adjuncts and levels of use are found in U.S. Pat. No. 6,653,275.

Suitable adjunct materials are commercially available from Mazer Chemicals (Gurnee, Ill., USA), Clariant Corporation (Glattbrugg, Switzerland), Rhodia Incorporated (Cranbury, N.J., USA), Scher Chemicals, Inc. (Clifton, N.J., USA), Dow Corning Corporation (Midland, Mich., USA) and General Electric Company (Fairfield, Conn., USA), Witco Corporation (Middlebury, Conn., USA), Degussa-Huls (Marl, Germany), BASF (Mount Olive, N.J., USA), Sigma-Aldrich (St. Louis, Mo., USA), 20 Microns Ltd. (Baroda, India), and Twin Rivers Technologies (Quincy, Mass., USA).

### EXAMPLES

The following compositions are examples of fabric care compositions useful in the present invention:

| | Examples | | | | | | | |
|---|---|---|---|---|---|---|---|---|
| Component | I | II | III | IV | V | VI | VII | VIII |
| Sucrose fatty ester-1^{a} | 14 | 14 | 14 | 14 | 21 | 0 | 0 | 0 |
| Sucrose fatty ester-2^{b} | 0 | 0 | 0 | 0 | 0 | 14 | 14 | 14 |
| CTMAC^{c} | 3.5 | 3.5 | 3.5 | 3.5 | 4.0 | 3.5 | 3.5 | 3.5 |
| Cationic polysaccharide-1^{d} | 2 | 0 | 1.5 | 0 | 2 | 0 | 1.5 | 0 |
| Cationic polysaccharide-2^{e} | 0 | 2 | 0 | 2 | 0 | 2 | 0 | 2 |
| Deposition agent-1^{f} | 0 | 0 | 0.5 | 0 | 0.5 | 0 | 0.5 | 0 |
| Deposition agent-2^{g} | 0 | 0 | 0 | 1 | 0 | 0 | 0 | 1 |
| Lactic acid | 0.5 | 0.5 | 0.5 | 0.5 | 0.5 | 0.5 | 0.5 | 0.5 |
| Proxel ®^{h} | 0.1 | 0.1 | 0.1 | 0.1 | 0.1 | 0.1 | 0.1 | 0.1 |
| Dantoguard ®ⁱ | 0.15 | 0.15 | 0.15 | 0.15 | 0.15 | 0.15 | 0.15 | 0.15 |
| TMBA^{j} | 0.05 | 0.05 | 0.05 | 0.05 | 0.05 | 0.05 | 0.05 | 0.05 |
| DTPA^{k} | 0.05 | 0.05 | 0.05 | 0.05 | 0.05 | 0.05 | 0.05 | 0.05 |
| Water | Bal. | Bal. | Bal. | Bal. | Bal. | Bal. | Bal. | Bal. |
| TOTAL | 100 | 100 | 100 | 100 | 100 | 100 | 100 | 100 |

^{a}Sucrose fatty ester-1 = sucrose fatty ester derived from soy bean oil with average esterification of 7.5 on each sucrose.
^{b}Sucrose fatty ester-2 = sucrose fatty ester derived from soy bean oil with average esterification of 4 on each sucrose.
^{c}CTMAC = cetyl trimethyl ammonium chloride.
^{d}Cationically modified starch having a charge density of 0.18 meq/gram and WF = 78
^{e}Cationically modified starch having a charge density of 0.36 meq/gram and WF = 84
^{f}Polyvinylamine (PVAm) from BASF.
^{g}Cationic polyacrylamide: Sedipur ® CF803 from BASF.
^{h}Proxel ® = 1,2-benzisothiozolin-3-one.
ⁱDantoguard ® = dimethylol-5,5-dimethylhydantoin.
^{j}TMBA = trimethoxy benzoic acid.
^{k}DTPA = sodium diethylene triamine pentaacetate

The following compositions are examples of fabric care compositions, comprising sucrose fatty esters, cationic starch, deposition polymers, and adjunct fabric care materials, useful in the present invention:

| | Examples | | | | | | | |
|---|---|---|---|---|---|---|---|---|
| Component | IX | X | XI | XII | XIII | XIV | XV | XVI |
| Sucrose fatty ester-1^{a} | 7 | 7 | 7 | 14 | 0 | 0 | 0 | 0 |
| Sucrose fatty ester-2^{b} | 0 | 0 | 0 | 0 | 7 | 7 | 7 | 14 |
| CTMAC^{c} | 1.5 | 2 | 2 | 3.5 | 1.5 | 2 | 2 | 3.5 |
| DTDMAC^{l} | 8 | 0 | 0 | 0 | 8 | 0 | 0 | 0 |
| DEEDMAC^{m} | 0 | 7 | 7 | 0 | 0 | 7 | 16 | 0 |
| TEEMAMSⁿ | 0 | 0 | 0 | 14 | 0 | 0 | 0 | 14 |
| Cationic polysaccharide-1^{d} | 2 | 2 | 2 | 1 | 2 | 2 | 1.5 | 1 |
| Deposition agent-1^{f} | 0 | 0 | 0.5 | 0.5. | 0 | 0.25 | 0.5 | 0.5 |
| Lactic acid | 0.5 | 0.5 | 0.5 | 0.5 | 0.5 | 0.5 | 0.5 | 0.5 |
| Proxel ®^{h} | 0.1 | 0.1 | 0.1 | 0.1 | 0.1 | 0.1 | 0.1 | 0.1 |
| Dantoguard ®ⁱ | 0.15 | 0.15 | 0.15 | 0.15 | 0.15 | 0.15 | 0.15 | 0.15 |
| TMBA^{j} | 0.05 | 0.05 | 0.05 | 0.05 | 0.05 | 0.05 | 0.05 | 0.05 |
| DTPA^{k} | 0.05 | 0.05 | 0.05 | 0.05 | 0.05 | 0.05 | 0.05 | 0.05 |
| Water | Bal. | Bal. | Bal. | Bal. | Bal. | Bal. | Bal. | Bal. |
| TOTAL | 100 | 100 | 100 | 100 | 100 | 100 | 100 | 100 |

^{l}DTDMAC = di-tallow di-methyl ammonium chloride.
^{m}DEEDMAC = di-tallowoylethanolester dimethylammonium chloride.
ⁿTEEMAMS = triethanol amine ester methyl ammonium methylsulfate.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric care composition comprising:
(a) a sucrose ester fabric care material having the formula:
M(OH)₈₋ₓ(OC(O)R¹)ₓ
wherein
M is a disaccharide backbone of sucrose; x is the number of esterified hydroxyl groups and is an integer selected from 1 to 8; and R¹ is independently selected from C1-C22 alkyl or C1-C30 alkoxy groups, which are linear or branched, cyclic or acyclic, saturated or unsaturated, substituted or unsubstituted;
(b) a cationic polysaccharide;
(c) an emulsifier comprising a cationic surfactant, an amphoteric surfactant or mixtures thereof; and
(d) a dispersing medium.

2. The composition of claim 1 wherein the cationic polysaccharide has a charge density of from about 0.05 to about 5.5 meq/gram.

3. The composition of claim 1 wherein the cationic polysaccharide is selected from the group consisting of cationic guar gums, cationic cellulose derivatives, cationic starch, cationic chitosan derivatives, and mixtures thereof.

4. The composition of claim 1 wherein the cationic polysaccharide has a weight average molecular weight from about 50,000 daltons to about 10,000,000 daltons.

5. The composition of claim 1 wherein the cationic polysaccharide is hydrolyzed cationic starch has one or both of the following properties:
i) a charge density from about 0.05 to about 5.5 meq/gram;
ii) a water fluidity from about 50 to about 85.

6. The composition of claim 1 wherein the composition further comprises a deposition agent selected from the group consisting of: non-quaternary nitrogen-containing acrylic or vinyl materials, non-polysaccharide polyquaterniums and other polymeric cationic quaternary materials, and mixtures thereof.

7. The composition of claim 1 wherein the dispersing medium is water or a solvent selected from the group consisting of C4 to C10 glycol ethers, C2 to C7 glycols, polyethers, and mixtures thereof.

8. The composition of claim 1 wherein the composition further comprises one or more adjunct material selected from the group consisting of: a wetting agent; a nonionic polymer, a viscosity modifier; a pH buffer; an antibacterial agent; an antioxidant; a radical scavenger; a chelant; an antifoaming agent; a softening agent; a perfume; and mixtures thereof.

9. A composition comprising:
(a) from about 1% to about 70% by weight of the composition of a sucrose ester fabric care material;
(b) from about 0.1% to about 20% by weight of the composition of a cationic polysaccharide;
(c) from about 0.3% to about 25% by weight of the composition of an emulsifier comprising a cationic surfactant, an amphoteric surfactant or mixtures thereof;
(d) optionally, from about 30% to about 98% by weight of the composition of a dispersing medium;
(e) optionally, from about 0.1% to about 15% by weight of the composition of a deposition agent; and
(f) optionally no more than about 30% by weight of the composition of an adjunct material.

10. The composition of claim 9 wherein the sucrose ester fabric care material has the formula:
M(OH)₈₋ₓ(OC(O)R¹)ₓ
wherein
M is a disaccharide backbone of sucrose; x is the number of esterified hydroxyl groups and is an integer selected from 1 to 8; and R¹ is independently selected from C1-C22 alkyl or C1-C30 alkoxy groups, which are linear or branched, cyclic or acyclic, saturated or unsaturated, substituted or unsubstituted.

11. The composition of claim 9 wherein the cationic polysaccharide has a charge density of from about 0.05 to about 5.5 meq/gram;

12. The composition of claim 11 wherein the cationic polysaccharide is selected from the group consisting of cationic guar gums, cationic cellulose derivatives, cationic starch, chitosan derivatives, and mixtures thereof.

13. The composition of claim 9 wherein the dispersing medium is water or a solvent selected from the group consisting of C4 to C10 glycol ethers, C2 to C7 glycols, polyethers, and mixtures thereof.

14. The composition of claim 9 wherein the deposition agent is selected from the group consisting of non-quaternary nitrogen-containing compounds, non-polysaccharide polyquaterniums and other polymeric cationic quaternary materials, and mixtures thereof.

15. The composition of claim 9 wherein the deposition agent is selected from the group consisting of polyvinyl amine, polyethyleneimine, polyamido-polyethyleneimine, ethoxylated polyethyleneimine, polyacrylamide, poly(2-dimethylaminoethyl methacrylate), polyaminoacid, polylysine aminocaproic acid derivatives, polyvinylpyrrolidone, polyvinylpyridine-N-oxide, polyvinylpyrrolidone vinyl imadazole, copolymer of vinylpyrrodlidone and dimethylaminoethyl methacrylate, polyquaternium 2, polyquaternium 6, polyquaternium 7, polyquaternium 11, polyquaternium 16, polyquaternium 17, polyquaternium 18, polyquaternium 22, polyquaternium 28, cationic polyacrylamide, poly(2-acryloyloxyethyl)trimethylammonium cation, polymethylacrylamidopropyl trimethylammonium cation, copolymers of polyamide, polyether and polyethyleneimine, and mixtures thereof.

16. The composition of claim 9 wherein adjunct material selected from the group consisting of: a wetting agent; a nonionic polymer, a viscosity modifier; a pH buffer; an antibacterial agent; an antioxidant; a radical scavenger; a chelant; an antifoaming agent; a softening agent; a perfume; and mixtures thereof.

17. The composition of claim 9 wherein the adjunct material is selected from the group consisting of wrinkle releasing/prevention agent, anti-static agent, crystal modifier, soil release/prevention agent, colorant, brightener, odor reducer/eliminator, deodorizer/refresher agent, stain repellent, color enhancer, perfume release and/or delivery agent, shape retention agent, fiber rebuild agent, fiber repair agent, and mixtures thereof.

18. The composition of claim 9 wherein the composition has a viscosity of from about 1 cps to about 2000 cps.

19. A process of treating fabric articles comprising the step of contacting fabric articles with the composition of claim 1.

20. The process of claim 19 wherein the contacting step occurs during the wash cycle, the rinse cycle, the drying cycle, and combinations thereof.

21. A process of treating fabric articles comprising the step of contacting fabric articles with the composition of claim 9.

22. The process of claim 21 wherein the contacting step occurs during the wash cycle, the rinse cycle, the drying cycle, and combinations thereof.
